(19) United States
(12) Patent Application Publication
(10) Pub. No.: US 2006/0066083 A1
(43) Pub. Date: Mar. 30, 2006

(54) Gas bag module

(75) Inventor: Markus Keutz, Rossdorf (DE)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Automotive Safety Systems GmbH

(21) Appl. No.: 11/234,653

(22) Filed: Sep. 23, 2005

(30) Foreign Application Priority Data
Sep. 29, 2004 (DE) 20 2004 015 166.9

(51) Int. Cl. B60R 21/16

(52) U.S. Cl. 280/731

(57) ABSTRACT

A gas bag module for a vehicle occupant restraint device has a gas generator for inflating a gas bag, a discharge opening formed in a rigid component of the gas bag module, through which discharge opening gas generated by the gas generator and directed into the gas bag can be discharged, and an active valve with a valve body, which in a closing position closes the discharge opening and in an opening position releases the discharge opening. Upon opening, the valve body moves in a direction towards an interior of the gas bag module. A protective device is provided which prevents a contact between the valve body and the gas bag upon opening.

### TECHNICAL FIELD

The invention relates to a gas bag module for a vehicle occupant restraint device.

### BACKGROUND OF THE INVENTION

Usually, in a gas bag module, the gas bag is to be inflated as quickly as possible with the gas generated by the gas generator. In particular cases it is, however, desirable not to inflate the gas bag with the entire volume of gas which is available, or, more generally, to discharge gas, for which reason discharge openings are provided in the gas bag module, by the release of which the pressure in the gas bag can be limited.

To release the discharge openings, so-called active valves are known, i.e. valves which open (actively) for example in response to a particular signal and are not opened merely through the pressure or the temperature of the gas generated by the gas generator.

Gas bag modules are considered, in which a flap which is integrated into a rigid component of the module (“rigid” in the meaning of inflexible), e.g. the gas generator carrier, closes a discharge opening and releases it as required. For this, the flap is pivoted from a closing position into an opening position and thereby moves in the direction towards the interior of the gas bag module. Such an arrangement on the one hand offers the advantage of a stable accomodation of the discharge opening in a rigid component of the gas bag module, and on the other hand it can be employed more flexibly than a valve with an outwardly opening flap, as for example in the case of a driver's gas bag module only a limited construction space is available in the steering wheel hub.

It is an object of the invention to provide a gas bag module requiring little space, with a valve body closing a discharge opening, in which gas bag module the gas bag deploys as un-influenced as possible by the valve.

### BRIEF SUMMARY OF THE INVENTION

This is achieved by the gas bag module for a vehicle occupant restraint device according to the present invention, having a gas generator for inflating a gas bag, a discharge opening formed in a rigid component of the gas bag module, through which discharge opening gas generated by the gas generator and directed into the gas bag can be discharged, and an active valve with a valve body, which in a closing position closes the discharge opening and in an opening position releases the discharge opening. Upon opening, the valve body moves in a direction towards the interior of the gas bag module. A protective device is provided which prevents a contact between the valve body and the gas bag upon opening.

With the gas bag module proposed, the valve can open at a very early point of time in the deployment of the gas bag, in order to keep the stress exerted on an occupant low by discharging gas from the interior of the gas bag, without damage to the gas bag fabric being possible, or the opening behaviour of the flap being affected. In this way, mechanical damage to the gas bag can be ruled out. In addition, it is ensured that an undesired closing of the valve body through interaction with the unfolding gas bag does not occur.

Preferably, the protective device is at least partially arranged inside the gas bag. Thereby, a possible contact between the opening valve body and the gas bag can be prevented in a particularly reliable manner.

Advantageously, the protective device protects the gas bag from thermal overload. This is important in particular when a pyrotechnic drive is to be used for the release of the discharge opening. Through the protective device, a direct oncoming flow to the fabric is largely avoided.

According to a preferred embodiment, the protective device surrounds the valve body at least partially. This effectively prevents the valve body from being forced in a closing direction by the gas bag pressure and from closing partially or completely, which is important in particular in a phase of interaction with the vehicle occupant. In addition, such an arrangement offers protection from possible separating parts of the valve.

The protective device can surround the gas generator at least partially. Thereby, a portion of the gas generated by the gas generator can be directed towards the discharge opening in a controlled manner.

Advantageously, the protective device has a cage which is connected with the rigid component of the gas bag module. In this way, a particularly stable arrangement is produced, in which the protective device contributes to the stability of the entire module in an advantageous manner.

Preferably, a section of the gas bag is arranged between the cage and the rigid component of the gas bag module. The protective device thereby additionally serves for the fastening of the gas bag in the module, whereby a simple construction is produced with a minimum of components.

According to a preferred embodiment, the protective device has several recesses which affect a flow of the gas generated by the gas generator and introduced into the gas bag. Thus, through the shape, number and geometric arrangement of the recesses, a uniform inflating of the gas bag can be achieved, an additional component, in turn, being able to be dispensed with.

The valve body can comprise a flap which covers the discharge opening in the closing position and releases it in the opening position. Such a flap represents a particularly simple and nevertheless reliable release mechanism, which safely closes the discharge opening in the closing position.

According to a preferred embodiment, the valve body has a pyrotechnic unit which ensures a fast and reliable releasing of the discharge opening.

The pyrotechnic unit can have a separation bolt, which at the same time in the closing position represents a reliable fastening mechanism and also upon opening represents a fast releasing device for the valve body.

Advantageously, the valve body and the protective device are arranged with respect to each other so that the valve body strikes the protective device upon opening of the discharge opening. In this way, the protective device absorbs the energy of the opening valve body and prevents a contact thereof with the gas bag.

### BRIEF DESCRIPTION OF THE DRAWINGS

FIG. 1 shows a side view of a gas bag module according to the invention, partially in section.

### DETAILED DESCRIPTION OF THE PREFERRED EMBODIMENT

The FIGURE shows part of a gas bag module 10 which is particularly intended for a driver's gas bag module, but is not restricted thereto. The gas bag module 10 has a gas generator 12 and a gas bag 14, only indicated in the FIGURE, and is delimited in the non-released state by a covering cap 15 directed towards a vehicle occupant. Additionally provided are a holding plate 16 and a generator carrier 17 with a discharge opening 18 formed therein, which can be closed by means of a valve body 20 or, as shown in the FIGURE, can be released. The discharge opening 18 and the valve body 20 therefore form a valve for limiting an internal pressure of the gas bag.

The valve body 20 has a flap 22 which in the closing position covers the discharge opening 18. In the case of an actuation of the valve, the flap 22 pivots upwards upon a bending hinge 24, into an interior 26 of the gas bag module 10, as shown in the FIGURE. For actuation of the valve, a pyrotechnic unit in the form of a separation bolt 28 is provided as a drive means, the separation bolt 28 consisting of a lower part 30 and an upper part 32. The separation bolt 28 is illustrated oversized in the FIGURE, for clarification.

The valve body 20 is connected with the holding plate 16 or the generator carrier 17 so that a pivoting of the flap 22 upon the bending hinge 24 is possible in the case of an activation of the valve. Here, the flap 22 can be constructed in one piece with the generator carrier 17 or as a separate component.

The gas bag module 10 further has a protective device in the form of a cage 34, which is arranged inside the gas bag 14 and surrounds the gas generator 12, the discharge opening 18, and the valve body 20. The cage 34 is substantially cup-shaped and is securely connected with the holding plate 16 or the generator carrier 17, for example by means of a screw connection. Here, a section of the gas bag 14, also called an inflation opening, is clamped between the cage 34 and the generator carrier 17, for the purpose of fastening. Furthermore, the cage 34 has several recesses 36 which are arranged along its side wall.

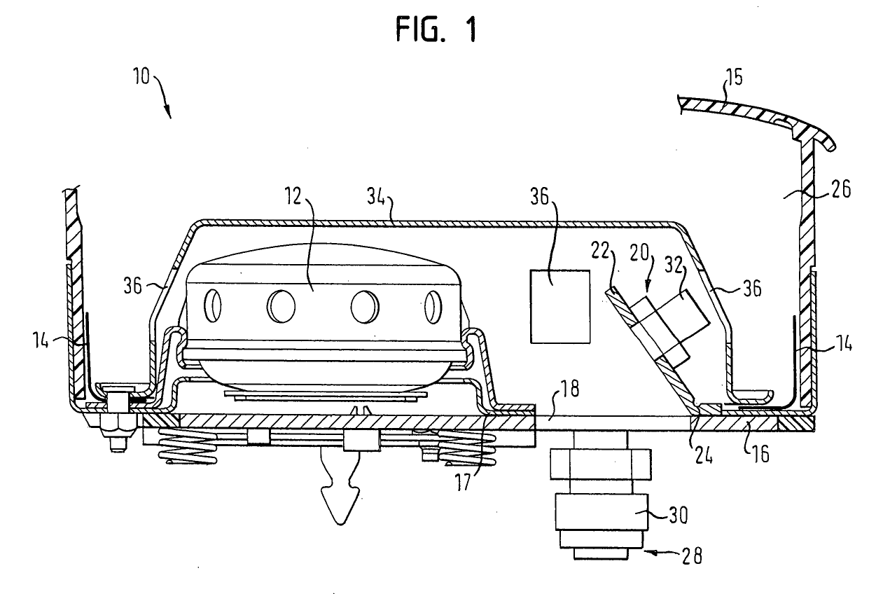

If a situation occurs in which it is necessary to reduce the internal pressure of the gas bag 14 which is deploying or has already deployed, through actuation of the separation bolt 28 the valve body 20 is brought from the closing position, in which the flap 22 rests horizontally on the holding plate 16, into the opening position shown in FIG. 1 with released discharge opening 18. Thereby, the flap 22 is forced upwards about the bending hinge 24 in a direction towards the interior 26 of the gas bag module 10, with either the upper part 32 of the separation bolt 28 or the flap 22 striking the cage 34, depending on the shape and geometric arrangement of the recesses 36. Thereby, a contact of the valve body 20 and of the drive means with the gas bag 14 is prevented.

Thus, on the one hand, the possibility of a mechanical damage to the gas bag fabric by the opening flap 22 or the upper part 32 of the separation bolt 28 is ruled out; on the other hand, an unintended closing of the flap 22 owing to an interaction with the not yet fully unfolded gas bag 14 is avoided. A partial or complete closure of the valve could also occur in a later phase of the gas bag performance, for example only through interaction with a vehicle occupant, if the flap 22 of the valve is forced downwards, i.e. in closing direction, through the gas bag pressure. This is also prevented by the cage 34.

1. A gas bag module for a vehicle occupant restraint device, comprising
a gas generator (12) for inflating a gas bag (14),
a discharge opening (18) formed in a rigid component of said gas bag module (10), through which discharge opening (18) gas generated by said gas generator (12) and directed into said gas bag (14) can be discharged,
an active valve with a valve body (20), which in a closing position closes said discharge opening (18) and in an opening position releases said discharge opening (18), said valve body (20) moving in a direction towards an interior (26) of said gas bag module (10) upon opening,
and a protective device, which prevents a contact between said valve body (20) and said gas bag (14) upon opening.

2. The gas bag module according to claim 1, wherein said protective device is arranged at least partially inside said gas bag (14).

3. The gas bag module according to claim 1, wherein said protective device protects said gas bag (14) from thermal overload.

4. The gas bag module according to claim 1, wherein said protective device surrounds said valve body (20) at least partially.

5. The gas bag module according to claim 1, wherein said protective device surrounds said gas generator (12) at least partially.

6. The gas bag module according to claim 1, wherein said protective device has a cage (34) which is connected with said rigid component of said gas bag module (10).

7. The gas bag module according to claim 6, wherein a section of said gas bag (14) is arranged between said cage (34) and said rigid component of said gas bag module (10).

8. The gas bag module according to claim 1, wherein said protective device has several recesses (36) which affect a flow of said gas generated by said gas generator (12) and introduced into said gas bag (14).

9. The gas bag module according to claim 1, wherein said valve body (20) comprises a flap (22) which covers said discharge opening (18) in said closing position and releases it in said opening position.

10. The gas bag module according to claim 1, wherein at least one section of a drive means for actuating said valve is arranged on said valve body (20) and said protective device prevents a direct contact of said drive means with said gas bag (14) upon opening.

11. The gas bag module according to claim 1, wherein said valve body (20) has a pyrotechnic unit.

12. The gas bag module according to claim 11, wherein said pyrotechnic unit has a separation bolt (28).

13. The gas bag module according to claim 1, wherein said valve body (20) and said protective device are arranged with respect to each other so that said valve body (20) strikes said protective device upon opening of said discharge opening (18).
